(19) United States
(12) Patent Application Publication
(10) Pub. No.: US 2023/0115612 A1
(43) Pub. Date: Apr. 13, 2023

(54) ENGINE WITH CYLINDER CRANKCASE AND OIL RETURN COLLECTION CHANNEL AND OIL DRAIN

(71) Applicant: DEUTZ Aktiengesellschaft, Koeln (DE)

(72) Inventor: Marco SLIWA, Siegburg (DE)

(21) Appl. No.: 17/802,988

(22) PCT Filed: Feb. 25, 2021
(86) PCT No.: PCT/EP2021/000021

§ 371 Date: Aug. 29, 2022

(30) Foreign Application Priority Data
Mar. 2, 2020 (DE) 102020001339.2

(51) Int. Cl. F01M 11/02; F02B 75/18

(52) U.S. Cl. CPC F01M 11/02; F02B 75/18

(57) ABSTRACT

An internal combustion engine, in particular, a diesel internal combustion engine, including a cylinder crankcase (1), at least one oil return collection groove (2), at least one oil drain (3), in which depressurized oil (4) discharges in the direction of the oil pan, following gravity, and at least one cylinder (5) is provided.

The present disclosure relates to an engine including a cylinder crankcase and an oil return collection groove and oil drains.

### BACKGROUND

An internal combustion engine is known from DE 102015101410 A1, including a cylinder crankcase, an oil pan, which during operation is filled with oil up to an oil level, an oil pan upper part including at least one passage aperture and an oil return, which includes at least one oil channel and which is used to return oil, in particular, from the oil separation, into the oil pan.

DE 100 26 113 B4 shows an internal combustion engine including an oil pan upper part, which is situated between a crank pit and an oil pan and which is held between a cylinder crankcase and an adjoining portion of an oil pan. An oil channel extends in such a way that the oil returned from the cylinder head is conducted into the oil pan below the oil level.

A reciprocating piston internal combustion engine is known from DE 19754008 C2, including a cylinder head accommodating valves as gas exchange control elements and a crankcase accommodating a crankshaft, in which the cylinder head and the crankcase, made up of a crankcase upper part and a crankcase lower part, are continuously braced with respect to one another with the aid of tie rods, which are anchored in the lower area of the cylinder head facing the crankcase and which are braced in the area of the crankcase lower part against bearing blocks forming bearing receptacles of the crankshaft, the crankcase lower part having a double-walled design and, for delimiting the sump, including a sump bottom surrounding the bearing blocks, from which an outer crankcase bottom is situated spaced apart, and the crankcase bottom, in the area of boreholes for the tie rods which extend through the bearing blocks, being drawn in toward the sump bottom, in such a way that the screw elements associated with the tie rods are situated in receptacles drawn in in a pocket-shaped manner which are delimited by the bearing blocks.

In WO 2012175275 A1, an oil gallery is situated in the area of the cylinder head of the head-block unit, from which a supply borehole to a lubricant supply channel leads to the bearing bushing of the shaft of the exhaust gas turbocharger. A transfer opening for the oil return and the sealing air discharge, which opens into the lubricant return channel, is situated in the flange of the exhaust gas turbocharger. The lubricant return channel, which may also be drilled and closed by a screw plug or a core hole plug, leads via the vertical portion of the return line back into the oil pan.

### SUMMARY

Very high importance is attached to compactness during the development of engines. It is crucial to represent as many functions as possible in a small installation space. Today's designs show cylinder crankcases including individual oil drains for each cylinder, which allow the depressurized oil to flow into the engine block, and later back into the oil pan.

One alternative could be fewer oil drains and a combination of depressurized oil volumes in the cylinder head. This variant has the disadvantage that the cylinder head is weakened in its structure in the area where the oil from two or multiple cylinders merges.

In the process, it is disadvantageous that the individual oil drains in the cylinder crankcase take up a lot of space or the structure is weakened.

It is an object of the present disclosure to avoid the above-described disadvantages and to create a compact and stable engine.

The present disclosure provides an internal combustion engine, in particular, a diesel internal combustion engine, including a cylinder crankcase (1), at least one oil return collection groove (2), at least one oil drain (3), in which depressurized oil (4) discharges in the direction of the oil pan, following gravity, and at least one cylinder (5). The present disclosure is described in greater detail hereafter based on the figure.

### BRIEF DESCRIPTION OF THE DRAWINGS

FIG. 1 shows an internal combustion engine according to the present disclosure with a view onto the crankcase open at the top.

### DETAILED DESCRIPTION

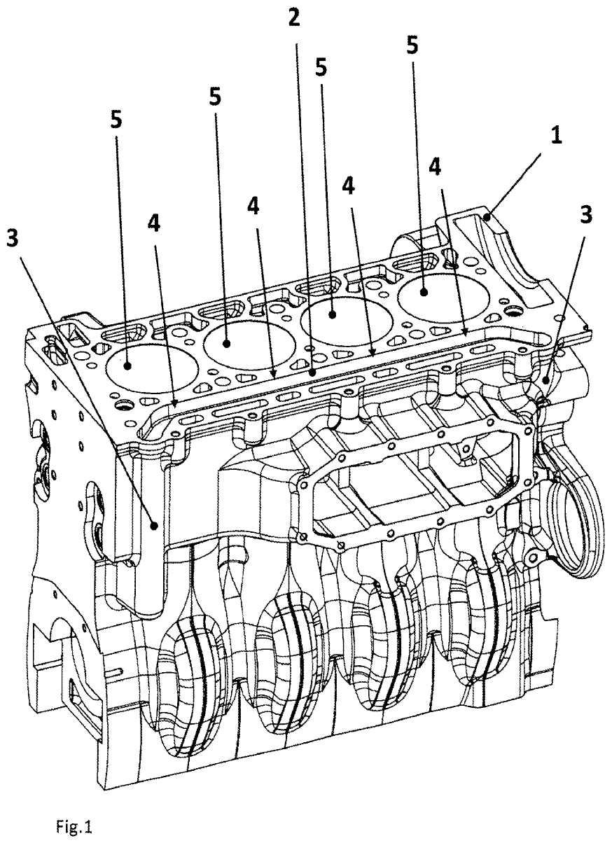

The present design shows many functions in a small installation space, which does not weaken the structure of the cylinder head at the same time. In the approach shown in FIG. 1, depressurized oil 4 is transferred from the cylinder head of each cylinder 5 to cylinder crankcase 1 in such a way that it is transferred in the one oil return collection groove 2 situated horizontally in the area of the separation plane between the head and the block. In this way, the construction of a clean structure in the cylinder, without limitations, is possible. An oil return collection groove 2 is cast or machined into cylinder crankcase 1. Oil return collection groove 2 merges the depressurized oil from the individual cylinder areas of the cylinder head, collects it and conducts it onward to cast-on or machined-on oil drains 3, which are vertically situated in the area of the first and last cylinders, in the direction of the oil pan. In this way, space is created beneath the oil return collection groove 2 for water channels and for further modules to be provided, such as, for example, cooling cassettes or the like.

### LIST OF REFERENCE NUMERALS

1 cylinder crankcase
2 oil return collection groove
3 oil drain
4 depressurized oil
5 cylinder

1-5. (canceled)

6. An internal combustion engine comprising
a cylinder crankcase;
a cylinder head;
multiple cylinders including a first cylinder and a last cylinder;
at least one oil return collection groove essentially situated in an area of a separation lane of the cylinder crankcase and the cylinder head and extending from the first cylinder to the last cylinder; and
two vertically situated oil drains each in an area of a respective one of the first and last cylinders, two vertically situated oil drains configured for discharging depressurized oil in a direction of an oil pan, following gravity,
the at least one oil return collection groove being configured in such a way that depressurized oil from the individual cylinder areas of the cylinder head is merged, collected and conducted onward to oil drains in the area of the first and last cylinders.

7. The internal combustion engine as recited in claim 6, wherein the oil return collection groove is essentially horizontally situated.

8. The internal combustion engine as recited in claim 6, wherein the oil return collection groove is recessed into a top planar surface of the cylinder crankcase and extends continuously along the top planar surface such that a first end of the oil return collection groove is longitudinally past the first cylinder and a second end of the oil return collection groove is longitudinally past the last cylinder.

9. The internal combustion engine as recited in claim 6, wherein the oil return collection groove is recessed into a top planar surface of the cylinder crankcase and extends continuously along the top planar surface such that a first end of the oil return collection groove protrudes laterally away from the first cylinder and a second end of the oil return collection groove is protrudes laterally away from the last cylinder.
